(19) United States
(12) Patent Application Publication
(10) Pub. No.: US 2026/0136117 A1
(43) Pub. Date: May 14, 2026

(54) Optical Communication System Including Multiple Optical Fibers

(71) Applicant: Cspeed Inc., Palo Alto, CA (US)

(72) Inventors: Jingsi Li, Milpitas, CA (US); Stefanos Sidiropoulos, Palo Alto, CA (US); Sanjai Kohli, Los Altos Hills, CA (US)

(73) Assignee: Cspeed Inc., Palo Alto, CA (US)

(21) Appl. No.: 18/937,345

(22) Filed: Nov. 5, 2024

(51) Int. Cl. H04Q 11/00

(52) U.S. Cl. CPC H04Q 11/0003

(57) ABSTRACT

Apparatuses, methods, and systems for an optical communication system are disclosed. One method generating, by each of a plurality of M different selectable lasers of first transmitter system, an optical communication signal, selecting N of the M selectable lasers of first transmitter system based on feedback regarding a quality of each of the M different lasers when at least N of the selectable lasers are available, wherein N < M, and selecting I of the M selectable lasers of first transmitter system based on feedback regarding a quality of each of the M different lasers when less than N selectable lasers are available, wherein I < N, selecting and mapping, by the controller, an additional N-I lasers of a second transmitter system when less than N laser are available to the first transmitter system, and selecting the N or I selectable lasers for transmission of data streams.

### FIELD OF THE DESCRIBED EMBODIMENTS

The described embodiments relate generally to optical communications. More particularly, the described embodiments relate to systems, methods, and apparatuses for an optical communication system including multiple optical fibers.

### BACKGROUND

Much of cloud-based infrastructure is based on storage and processing of data by large numbers of servers in data centers. These servers are connected through a switch network in various configurations. Data centers increasingly rely on interconnects for delivering critical communications connectivity among numerous servers, memory, and computation resources. Data center interconnects have turned to optical communications, and the recent acceleration in data center requirements is expected to further drive optical interconnect technologies deeper into the systems architecture.

However, the lasers that generate optical signals to be carried by optical fibers within data centers are unreliable and can have a short life.

It is desirable to have methods, apparatuses, and systems for optical communication systems including multiple optical fibers that can be utilized within data centers.

### SUMMARY

An embodiment includes an optical communication system including a first transmitter system including M different selectable lasers, each of the M different lasers configured to generate an optical communication signal having a carrier optical frequency within a corresponding channel that is different than a carrier optical frequency and corresponding channel of each of other M-1 different lasers of the M lasers a first controller configured to select and map N of the M selectable lasers based on feedback regarding a quality of each of the M different lasers when at least N of the selectable lasers are available, wherein N < M, and configured to select and map I of the M selectable lasers based on feedback regarding a quality of each of the M different lasers when less than N of the M selectable lasers are available, wherein I < N, wherein a second transmitter system is configured to select and map an additional N-I lasers to accommodate for the less than N laser available to the first transmitter when less than N lasers are available, and a first switch selector configured to select the N or I of the M selectable lasers for transmission over a first optical fiber to a first optical receiver system.

Another embodiment includes a method of an optical communication system. The method includes generating, by each of a plurality of M different selectable lasers of first transmitter system, an optical communication signal having a carrier optical frequency within a corresponding channel that is different than a carrier optical frequency and corresponding channel of each of other M-1 different lasers of the M lasers, selecting and mapping, by a controller, N of the M selectable lasers of first transmitter system based on feedback regarding a quality of each of the M different lasers when at least N of the selectable lasers are available, wherein N < M, and selecting and mapping, by the controller, I of the M selectable lasers of first transmitter system based on feedback regarding a quality of each of the M different lasers when less than N of the M selectable lasers are available, wherein I < N, selecting and mapping, by the controller, an additional N-I lasers of a second transmitter system when less than N laser are available to the first transmitter system, and selecting, by a first switch selector, the N or I of the M selectable lasers for transmission of data streams over a first optical fiber to a first optical receiver system.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an optical communication system, according to an embodiment.

FIG. 2 shows an optical communication system, according to another embodiment.

FIG. 3 shows passband filtering of each carrier signal of an optical transmitter system, according to an embodiment.

FIG. 4 is a frequency spectrum of carrier signals of the optical communication system, according to an embodiment.

FIG. 5 shows power curves of a laser, according to an embodiment.

FIG. 6 shows a frequency spectrum of carrier signals of the optical communication system in which carrier signals are selected to reduce inter-channel interference, according to an embodiment.

FIG. 7 shows a data stream and an analog signal modulated onto a carrier signal, according to an embodiment.

FIG. 8 is a flow chart that includes steps of a method of an optical communication system, according to an embodiment.

FIG. 9 is a flow chart that includes steps of a method of an optical transmitter system, according to an embodiment.

FIG. 10 shows a pair of optical communication systems, according to an embodiment.

FIG. 11 shows examples of coding of laser transmission bit streams, according to embodiments.

### DETAILED DESCRIPTION

The embodiments described include methods, apparatuses, and systems for an optical communication system. For an embodiment, the optical communication system includes a plurality of optical transmitter systems that each drive one of a plurality of optical fibers, wherein each of the plurality of parallel optical fibers is connected to a corresponding optical receiver. For an embodiment, at least one of the plurality of optical transmitter systems includes M different selectable lasers, each of the M different lasers configured to generate an optical communication signal having a carrier optical frequency within a corresponding channel that is different that a carrier. That is, the carrier optical frequency of each of the M different lasers is within a different channel. The optical communication system further includes a controller that is configured to select and map N of the M selectable lasers based on feedback of a quality of one or more of the M lasers, wherein N < M, and configured to select and map I of the M selectable lasers based on feedback regarding a quality of each of the M different lasers when less than N of the M selectable lasers are available, wherein I < N. A second transmitter system is configured to select and map an additional N-I lasers to accommodate for the less than N laser available to the first transmitter system when less than N lasers are available. A first switch selector configured to select the N or I of the M selectable lasers for transmission over a first optical fiber to a first optical receiver system.

As disclosed, each of the transmitter systems of the optical communication system is connected to a different optical fiber. For an embodiment, each of the transmitter systems connected to a different optical fiber is designated as a “bundle”. Each bundle includes M (for example, 20) optical lasers that each generate an optical signal within a corresponding one of M transmission channels. For an embodiment, each of the bundles is designed to operate with N (for example, 16) operating lasers. However, if less than 16 (N) lasers of a one of the transmitted systems are available due to degradation of one or more of the lasers, another one of the transmitters systems may be utilized to provide an “extra” laser to be used to transmit a data stream that would have been transmitted by the one of the transmitter systems.

For example, each transmitter system (bundle) includes 20 lasers and 20 corresponding transmission channels, wherein 16 lasers are intended for use and 4 are intended to be used as backup lasers. If each of the channels (lasers) of the multiple bundles are utilized as backup channels (lasers) of the other bundles then with 4 bundles there are 4x20 or 80 channels (lasers) available, wherein 4x16 or 64 channels are backed up by 16 redundant channels. This dramatically improves the overall system reliability. Further, the system reliability can be further improved by scaling up. That is, the system reliability can be scaled up by allowing each transmitter system to utilize redundant lasers of another of the transmitter systems.

A specific implementation of the optical transmitter system includes 4 (A) transmitter systems wherein each of the transmitter systems includes 16 (N) lasers fully operational until the end of life of the optical communication system. For example, the optical transmitter system may be required to be operational for 5 years in a data center with a probability of 99.999%. Performing a reliability analysis assuming an operating environment may indicate that 2 lasers will fail with a certain probability. For an embodiment, to ensure operation of the 16 lasers, the results of the analysis suggest that operation be started with 18 (M) lasers, with the assumption that 2 of the lasers will fail over the useful lifetime of the system. However, with multiple optical transmitter systems operating to communicate optical signals over parallel optical fibers, the end of life of the optical communication system can be extended by utilizing neighboring optical transmitters when one or more of the optical transmitters of the optical communication system has less than 16 operational lasers. That is, a spare (greater than 16) laser of a neighboring optical transmitter may be utilized when the one or more optical transmitters has less than 16 available lasers. As described, for an embodiment, spare lasers of a neighboring transmitter system can be utilized when less than the 16 lasers are available. That is redundancy is additionally provided by the neighboring transmitter system.

For an embodiment, burn-in of the lasers can additionally be accounted for in the redundancy. If the yield loss after burn-in is <=10%, the number M of lasers may be selected to be 20, thereby accounting for burn-in failure and end of life failure. Increasing the number of M lasers to 22 may yield a 50% chance that there will be 20 operational lasers out of 22 of each optical transmitter, thereby accounting for increasing wafer production yield.

At least some embodiments include increasing the value of M further to accommodate for manufacturing yield, elimination of burn-in etc.

An exemplary 800 Gbps optical transmitter system includes 16 operational lasers, with each laser having a payload data rate of 50 Gbps, and a coding overhead of 6 Gbps. Therefore, each laser must carry 56 Gbps. In order to realize 16 operational lasers in operation at the end of a 5-year useful life, factors including reliability calculations, environment of operation, data from accelerated testing, etc. Computing based on these factors suggests that 18 lasers are needed to guarantee 16 operational lasers. Further, burn-in tests indicate a loss of 1 laser out of 19 for a 5-year burn-in, suggesting 19 lasers are needed to be packaged. Further, it can be determined that production of just 19 lasers in the array results in a manufacturing yield that is extremely small (<10%). Empirical data and defect analysis suggests that 3 more lasers need to be added to increase the manufacturing yield to 50%. This all suggests that 22 lasers in the array are needed to provide a 50% manufacturing yield, elimination of the burn-in process, and to ensure 16 lasers operating laser at the end of life.

For an embodiment, each optical transmitter system is formed on an integrated circuit. For an embodiment, the integrated circuit may support a total bandwidth for the optical transmitter system of 4.4 THz. If the carrier optical frequency of each of the lasers of the optical transmitter system is spaced 200 GHz from the other lasers, then a total of only 22 different lasers may be formed, thereby limiting the number M of possible lasers in which the N lasers are selected. As previously described, for an embodiment, data speeds on the different channels of the different carrier optical frequencies can be or are different.

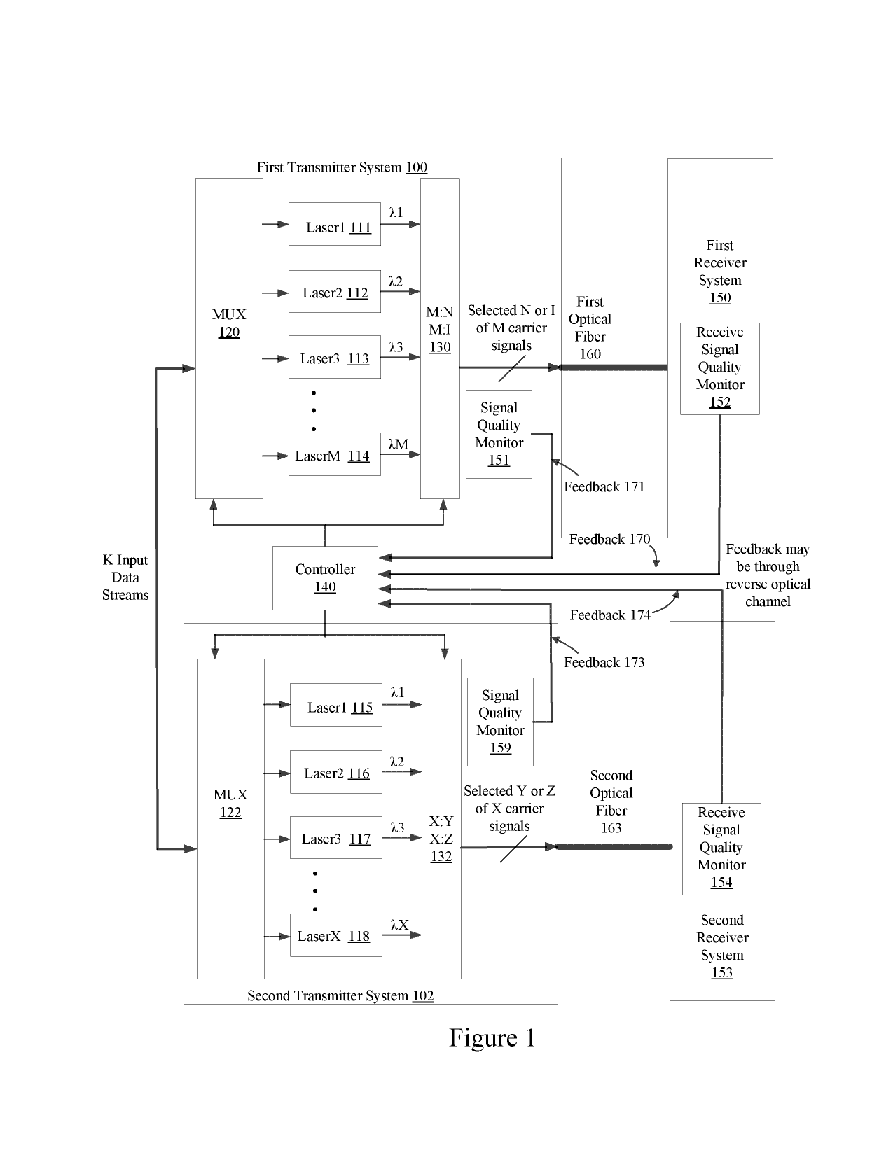

FIG. 1 shows an optical communication system, according to an embodiment. As shown, a first transmitter system 100 includes M different selectable lasers 111, 112, 113, 114, wherein each of the M different lasers 111, 112, 113, 114 is configured to generate an optical communication signal having a carrier optical frequency within a corresponding channel that is different that a carrier optical frequency and corresponding channel of each of the other M-1 different lasers of the M lasers. The channels corresponding with each of the carrier optical frequencies of each of the M lasers have designated center frequencies and frequency passbands, wherein the passbands of each of the channels are substantially non-overlapping in frequency.

Further, as shown, a second transmitter system 102 includes X different selectable lasers 115, 116, 117, 118, wherein each of the X different lasers 115, 116, 117, 118 is configured to generate an optical communication signal having a carrier optical frequency within a corresponding channel that is different that a carrier optical frequency and corresponding channel of each of the other M-1 different lasers of the M lasers. The channels corresponding with each of the carrier optical frequencies of each of the X lasers have designated center frequencies and frequency passbands, wherein the passbands of each of the channels are substantially non-overlapping in frequency. It is to be understood that while only two transmitters are shown, there can be any numbers of transmitters, such as 4, 8, 16, etc.

For an embodiment, M = X. For an embodiment, the M channels of the first transmitter system overlap with the X channels of the second transmitter system. However, for an embodiment, the M channels of the first transmitter system partially overlap or do not overlap with the X channels of the second transmitter system.

For an embodiment, a controller 140 is configured to select and map N of the M selectable lasers based on feedback regarding a quality of each of the M different lasers when at least N of the selectable lasers are available, wherein N < M, and configured to select and map I of the M selectable lasers based on feedback regarding a quality of each of the M different lasers when less than N of the M selectable lasers are available, wherein I < N. As will be described, the N lasers are selected to ensure a level of performance of N optical carrier signals propagating across a first optical fiber 160 to a first optical receiver system 150. Further, as described, the redundancy accounts for possible failure of one or more of the M lasers. Further, the performance of the M lasers can be monitored over time, and the N or I laser can be selected to ensure a preselected level of performance of the N or I optical carrier signals being communicated across the first optical fiber 160 to the first optical receiver system 150. For an embodiment, the selection of the N or I of the M selectable lasers is based on feedback regarding a quality of one or more of the M different lasers.

For an embodiment, when less than N of the M lasers of the first transmitter system 100 are available, then I of the M lasers are selected. For an embodiment, a laser is determined to be available when the laser is able to generate an optical carrier signal having at least a desired or selected level of signal quality when the laser is selected and activated. For an embodiment, the signal quality is based on one or more of an optical power, an SNR (signal to noise ratio), a bandwidth, a wavelength, and/or a BER (bit error rate) of the optical carrier signal generated by a laser.

For an embodiment, the second transmitter system 102 is configured to select and map an additional N-I lasers to accommodate for the less than N laser available to the first transmitter 101 when less than N lasers are available. That is, a spare laser located at the second transmitter system 102 is selected as a redundant backup for the less than N laser available at the first transmitter system 100.

For an embodiment, the first transmitter system 100 further includes a first switch selector 130 configured to select the N or I of the M selectable lasers for transmission over the first optical fiber 160 to the first optical receiver system 150. For an embodiment, the N or I lasers selected are active (powered), and the other M-N or M-I lasers are off (not powered). For an embodiment, all M lasers are active (powered) and the N or I lasers are selected to carry data streams.

For an embodiment, a multiplexer 120 or multiplexer 122 is configured to receive K input data streams and generate N or I laser data streams. For an embodiment, the multiplexers 120, 122 could be implemented with a single multiplexer. The K input data streams can be of varied data rates. For example, any one of the K input data streams may be 200 Gbps or 100 Gbps while each of the N or I laser data streams may be 50 Gbps. Any of the K input data streams may be 50Gbps or 25Gbps, while each of the N or I laser data streams may be 50Gbps. For an embodiment, the K input data streams are mapped to N or I laser data streams. The N or I selection is determined from the M lasers, and then the mapping of the K input data streams can be determined from the selected N or I lasers. For an embodiment, the first optical receiver system 150 needs to know the mapping of the K input data streams to the N or I laser data streams so that the first optical receiver system 150 can reconstruct the K input data streams after transmission through the optical fiber 160. Accordingly, for an embodiment the mapping of the K input data streams to the N or I selected lasers is communicated to the first optical receiver system 150.

For an embodiment, the controller 140 is further configured to communicate mapping of the N of the M selectable lasers to the first optical receiver system when at least N of the selectable lasers are available and communicate mapping I of the M selectable lasers to the first optical receiver system when less than N of the M selectable lasers are available.

For an embodiment, data stream of the N-I lasers of the first transmitter system 100 are directed to the second transmitter system 102 when less than the N lasers are available at the first transmitter system, wherein the second transmitter system 102 is configured to transmit the data streams of the N-I lasers over a second optical fiber 163 to a second optical receiver system 153.

As previously described, for an embodiment, the second transmitter system 102 includes X different selectable lasers, each of the X different lasers configured to generate an optical communication signal having a carrier optical frequency within a corresponding channel that is different than a carrier optical frequency and corresponding channel of each of other X-1 different lasers of the X lasers. Further, the controller is configured to select and map an additional N-I lasers at the second transmitter system 102 to accommodate for the less than N laser available to the first transmitter system, select and map Y + (N-I) of the X selectable lasers based on feedback regarding a quality of each of the X different lasers, wherein Y + (N-I) < =X. A second switch selector 132 is configured to select the Y + (N-I) of the X selectable lasers for transmission over a second optical fiber 163 to a second optical receiver system 153.

For an embodiment, the controller 140 is further configured to select and map an additional Y - Z lasers when less than Y lasers are available to the second transmitter system 102, wherein Z < Y. That is, when the second transmitter system 102 has less than Y available lasers, the second transmitter system 102 uses an extra laser from the first transmitter system 100 (or another transmitter system that has an available laser). For an embodiment, the first controller is further configured to select and map N + (Y-Z) of the M selectable lasers based on feedback regarding a quality of each of the M different lasers, wherein N + (Y-Z) < +M. Further, the first switch selector 130 is configured to select the N + (Y-Z) of the M selectable lasers for transmission over the first optical fiber 160 to the first optical receiver system 150.

As described, for an embodiment, the controller 140 is further configured to select and map Y of the X selectable lasers based on feedback regarding a quality of each of the X different lasers when at least N of the selectable lasers are available, wherein Y < X, and configured to select and map Z of the X selectable lasers based on feedback regarding a quality of each of the X different lasers when less than X of the Y selectable lasers are available, wherein Z < Y. Further, the controller 140 is configured to select and map an additional Y-Z lasers to accommodate for the less than Y laser available to the second transmitter system 102 when less than Y lasers are available. A second switch selector 133 of the second transmitter system 102 is configured to select the Y or Z of the X selectable lasers for transmission over a second optical fiber to a second optical receiver system.

For an embodiment, the optical communication system includes a plurality of A transmitter systems including the first transmitter system and the second transmitter system, wherein when one of more of the A transmitter systems do not have N lasers available, then one of more lasers of other of the A transmitter systems are selected to transmit data streams originally allocated to the N lasers not available. For example, if N = 16, and one of the A transmitter systems only have 14 lasers available, then that transmitter system operates with 14 (I) selected lasers, and 2 data streams originally allocated to the transmitter system are allocated to lasers of one or more of the other of the A transmitter systems. For an embodiment, the lasers of the other of the A transmitter systems are selected based on signal qualities of optical signals generated by the lasers. That is, for example, the 2 data streams could be allocated to two different of the other of the A transmitter systems if the two different of the other of the A transmitter systems have the two best lasers according to the signal quality of signals produced by the two best lasers. Further, for example, the 2 data streams could be allocated to a single one of the other of the A transmitter systems if the single one of the other of the A transmitter systems has the two best lasers according to the signal quality of signals produced by the two best lasers.

For an embodiment, the lasers of the other of the A transmitter systems are selected based on the thermal distribution of the lasers. That is, the lasers of each of the A transmitter systems are located on a substrate. Further, the active (selected) laser dissipates energy when operating which generates heat. Selected lasers proximate to each other contribute to thermal energy and heating of similar locations of the substrate. Accordingly, lasers of different transmitter systems may be selected to distribute the locations of the selected laser to control the heating of the substrates in which the lasers are located.

For an embodiment, the lasers of the other of the A transmitter systems are selected based on the crosstalk of the lasers. That is, as previously described, each of the lasers of a transmitter system generates an optical signal that occupies an allocated frequency spectrum (channel) that is different from each of the other lasers of the transmitter system. However, even though different channels are allocated to each of the lasers, some crosstalk between the lasers can occur. Accordingly, the selection of lasers of the A transmitter systems can be allocated to different of the A transmitter systems to reduce crosstalk between optical signals generated by the selected lasers of the A transmitter systems.

For an embodiment, A x N of A x M selected lasers are activated and the unselected lasers are not activated. That is, the selected lasers are activated and dissipate energy, and the unselected lasers are not activated, thereby saving energy and reducing the aging of the unselected lasers.

For an embodiment, the mapping of the A x N of A x M selected lasers is modulated on A x M lasers. That is, the optical receivers that receive the optical signals of the A transmitter systems need to know the mapping of the selected lasers so that the optical receivers know which data streams are associated with which of the A transmitter systems.

At least some embodiments include a multiplexer 120, 122 configured to receive K input data streams and generate A x N laser data streams, wherein each of the A x N laser data streams modulates a carrier signal of the selected A x N lasers, wherein a mapping of the A x K input data streams to the N laser data streams is modulated on each of the carrier signals of the selected N lasers. While the multiplexers 120, 122 are shown separately, it is to be understood that these multiplexers could be combined into a single representation of an electronic multiplexer.

For an embodiment, the A x M is selected based on at least a projected end of life of the M different selectable lasers. That is, the number of redundant lasers determines the projected life of the optical communication system which can be estimated based on the projected end of life of each of the lasers.

As previously described, for an embodiment, the mapping of the N or I of the M selectable lasers is modulated on each of the carrier signals of the selected N lasers. For an embodiment, the mapping of the K input data streams to the N selected lasers is modulated on each of the carrier signals of the selected N lasers. For an embodiment, the first and second optical receiver systems 150, 154 need to know which of the M and X lasers are selected so that the optical receiver systems 150, 154 know the frequency or wavelength in which the N or I carrier signals and channels of the N or I lasers are located. Accordingly, for an embodiment, all N or I of the carrier signals carry the mapping of the N of I of the M selectable lasers. For an embodiment, the mapping is included with all M carrier signals of which N or I are selected for transmission across the optical fibers 160, 163. For an embodiment the mapping is included over at least a time interval, wherein the optical receiver systems 150, 154 know when the time interval occurs.

As described, the M lasers are available for selecting the N or I laser to provide redundancy. That is, the laser can have a limited projected end of life. Accordingly, additional lasers can be included and selected from to ensure that at least a minimum number N of the laser are available for use. For an embodiment, the number M is selected based on knowledge and estimates of the projected end of life of the M different selectable lasers. It is to be understood that the number of M different selectable lasers can additionally be selected based on a burn-in rate of the lasers, and/or a manufacturing yield of the lasers. For an embodiment, the redundancy of the transmission system allows for elimination of “Infant mortality testing” of the lasers, sudden failures of the lasers in field, and long-term gradual wear-out of the lasers in field.

As previously described, the N or I selected lasers are selected based on a signal quality of each of the transmission signals of each of the M lasers. For an embodiment, the N or I selected lasers are selected from the M lasers based on a transmit power of N or I modulated carrier signals. For an embodiment, the N or I selected lasers are selected from the M lasers based on a signal quality or characteristic of the N modulated carrier signals. For an embodiment, the N or I selected lasers are selected from the M lasers based on an estimated BER (bit error rate) of N modulated carrier signals. For an embodiment, the N or I selected lasers are selected from the M lasers based on wavelength of N or I modulated carrier signals. For an embodiment, the N or I selected lasers are selected from the M lasers based on Side Mode Suppression Ratio (SMSR) of N modulated carrier signals.

As shown, for an embodiment, the controller 140 receives feedback 171 from a signal quality detector 151 within the first transmitter system 100. For an embodiment, the signal quality detector is as simple as a power detector of each of the N or I carrier signals. However, the signal quality detector can additionally or alternatively include other types of signal quality detectors. Further, as shown in FIG. 1, for an embodiment, feedback 170 from the first optical receiver system 150 includes receive signal quality monitor 152 of the N or I carrier signals received by the first optical receiver system 150. For an embodiment, two-way communication is supported by having optical transmitter systems and optical receiver systems on both sides of the first optical fiber 160. The feedback 170 can be received from the first optical receiver system 150 through a reverse communication channel back through the first optical fiber 160.

Further, as shown, for an embodiment, the controller 140 receives feedback 173 from a signal quality detector 159 within the second transmitter system 102. For an embodiment, the signal quality detector is as simple as a power detector of each of the Y or Z carrier signals. However, the signal quality detector can additionally or alternatively include other types of signal quality detectors. Further, as shown in FIG. 1, for an embodiment, feedback 174 from the second optical receiver system 153 includes receive signal quality monitor 154 of the Y or Z carrier signals received by the second optical receiver system 153. For an embodiment, two-way communication is supported by having optical transmitter systems and optical receiver systems on both sides of the second optical fiber 163. The feedback 174 can be received from the second optical receiver system 153 through a reverse communication channel back through the second optical fiber 163.

For an embodiment, the controller 140 is further configured to receive feedback from the first and second optical receiver system of the modulated lasers, and adaptively update the mapping of the N or I of the M selectable lasers and the Y or Z of the X selectable lasers based on the received feedback. For an embodiment, the feedback includes measured values of the signal qualities of each of the modulated carrier signals. The feedback 170, 173 provides real time or near real time feedback on the performance of the modulated carriers of the selected lasers. For an embodiment, upon startup, the selection provides a set of N or I selected lasers that meet a threshold level of communication quality. For an embodiment, upon startup, the selection provides a set of N or I selected lasers that provide the best level of communication quality. During operation, continual selection provides adaptive updating that meets the threshold level of communication quality, or the best level of communication quality.

For an embodiment, the controller 140 is further configured to track a history of the mapping over time, document the failed lasers, and adaptively influence the selection of the selected laser based on the history of the mapping. For example, tracking the performance over time can provide an indication of a particular one or more of the selected laser in which the performance is degrading over time. Such degradation can be used to trigger a reselection of the N or Y select lasers. Alternatively, the degradation may provide an indication that one or more lasers will fail, and therefore, trigger checking the selection of the N or Y laser more frequently. For an embodiment, the indication that one or more of the lasers will fail triggers a reselection of the N or Y laser that does not include the failing or previously failed laser.

For an embodiment, the controller 140 is further configured to code selected and non-selected lasers with the same code and track a signal quality of both the selected and non-selected lasers. For example, during a testing or calibration period or periods, the N selected lasers may be varied in order that unselected lasers may be tested as well. Using the same coding on all the carrier signals allows for even or fair testing and selection of the lasers. Further, an order or sequence of the selected N carrier signal may be tested for optimally testing signal quality and inter channel interference (ICI). An embodiment includes periodically (or triggered) testing of the non-selected laser over time. Therefore, the selected N or I lasers can be adapted over time.

For an embodiment, the controller 140 is further configured to receive feedback from the first and second optical receiver system 150, 153 of the modulated lasers, and adaptively adjust a coding of data streams of the modulated carriers. For an embodiment, the feedback includes a received signal quality which is tracked over time, and wherein the coding is increased for select of the modulated carrier signals as the received signal quality of one or more of the N modulated carrier signals degrades over time. For an embodiment, a threshold level of communication quality may be required of each of the carrier signals to ensure a threshold level of performance of the communication of the carrier signals across the optical fibers 160, 163. Accordingly, an embodiment includes increasing coding of one or more of the carrier signals to ensure that all of the carrier signals meet the threshold level of communication quality.

For an embodiment, the controller 140 is further configured to receive feedback from the first and second optical receiver system 150, 153 of the modulated lasers, and adaptively adjust an amplitude (power level) of the modulated carriers. For an embodiment, the feedback includes a received signal quality which is tracked over time, and a bias current is increased for select of the lasers as the received signal quality of one or more of the modulated carrier signals degrades over time.

For an embodiment, MAC (media access control) packets included as information within the modulated carrier signals of the N or I selected lasers include the mapping of the selection of the N or I of the M selectable lasers, thereby conveying the mapping to an optical receiver of the modulated carrier signals. For an embodiment, MAC (media access control) packets included as information within the modulated carrier signals of the N selected lasers include the mapping of the selection of the K bit streams to the N laser data streams, thereby conveying the mapping to an optical receiver of the modulated carrier signals.

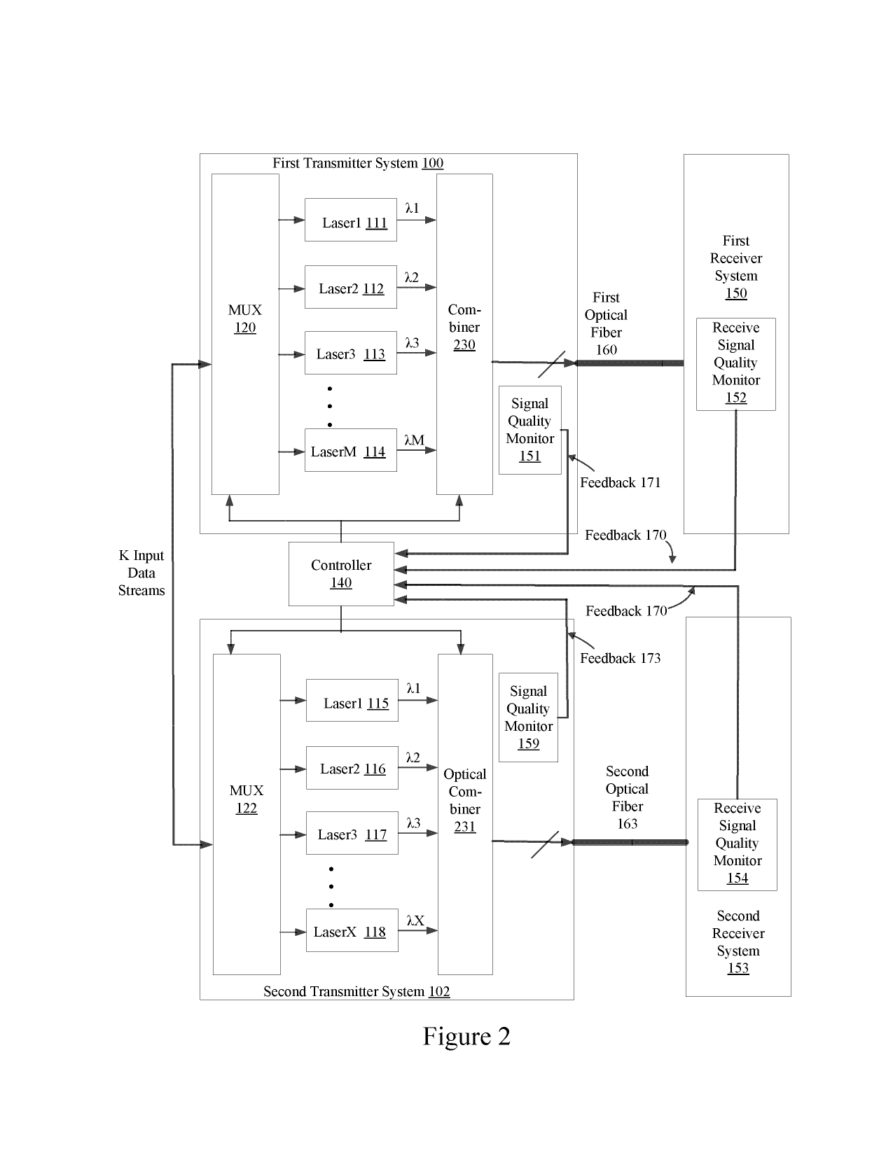

FIG. 2 shows an optical communication system, according to another embodiment. For this embodiment, the N or I selected lasers are selectively powered by the controller 140. This embodiment could advantageously reduce the amount of power consumed by the optical communication system because some of the lasers are not powered. The combiners 230, 232 receive the outputs from the active lasers and combine the outputs to the first and second optical fibers 160, 163. That is, no laser selection is made by the combiners 230, 232. Further, by not powering the unselected lasers, the unselected laser will be less likely to degrade over time. Therefore, if an unselected laser is later selected, then a prior characterization of a quality of the carrier signal of the unselected laser will likely still be a valid characterization.

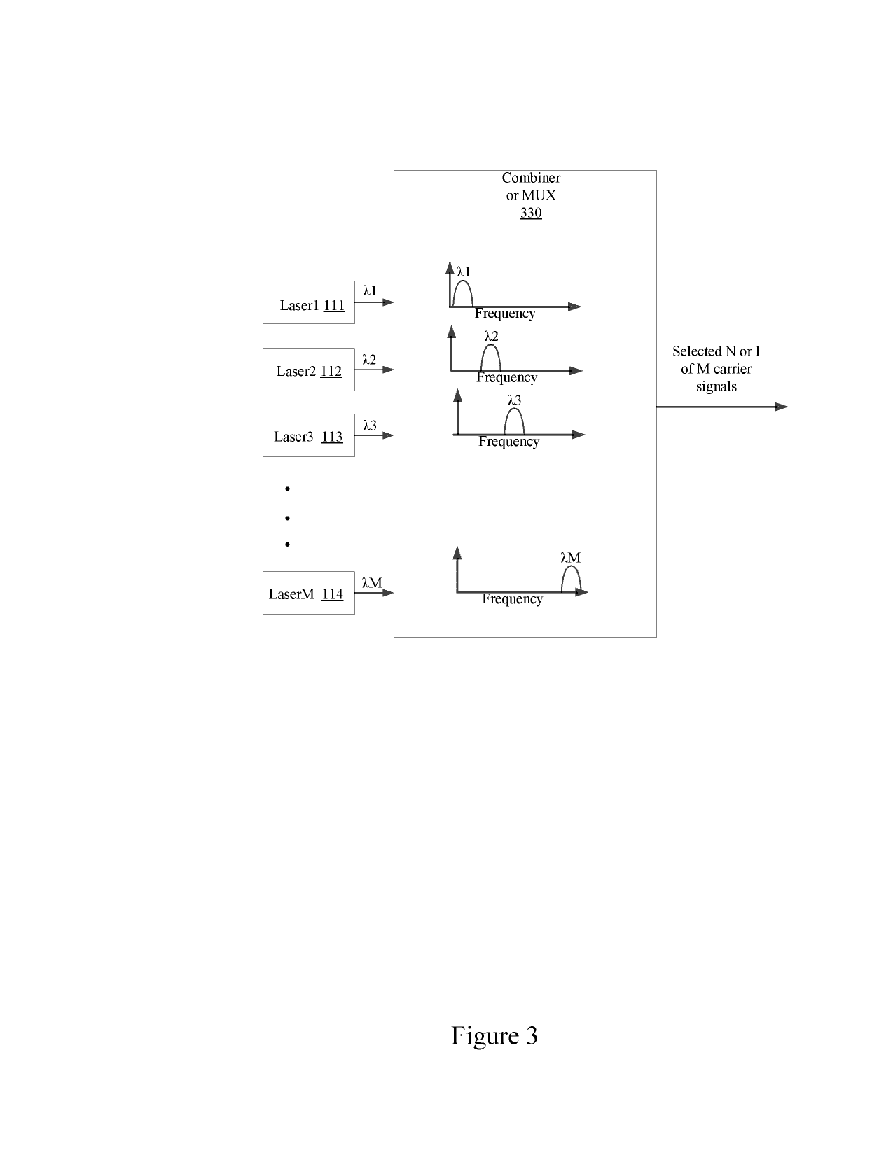

FIG. 3 shows passband filtering of each carrier signal of an optical transmitter system, according to an embodiment. As shown, the output of each of the lasers can be filtered by a bandpass filter (of a combiner or MUX 230) that is ideally centered at the wavelength of the corresponding carrier signal of the laser. The filtering reduces inter-channel interference (ICI) between carrier optical signals. For an embodiment, M different bandpass filters provide filtering of all M carrier optical signals of the M lasers. When only N of the M laser is active, the filtering occurs for the N carrier signals of the N lasers. However, the M bandpass filters are still present because the selected N of the M lasers can change at any time. For an embodiment, the bandpass filters are frequency aligned with the corresponding channel of each of the carrier optical frequencies of the M lasers.

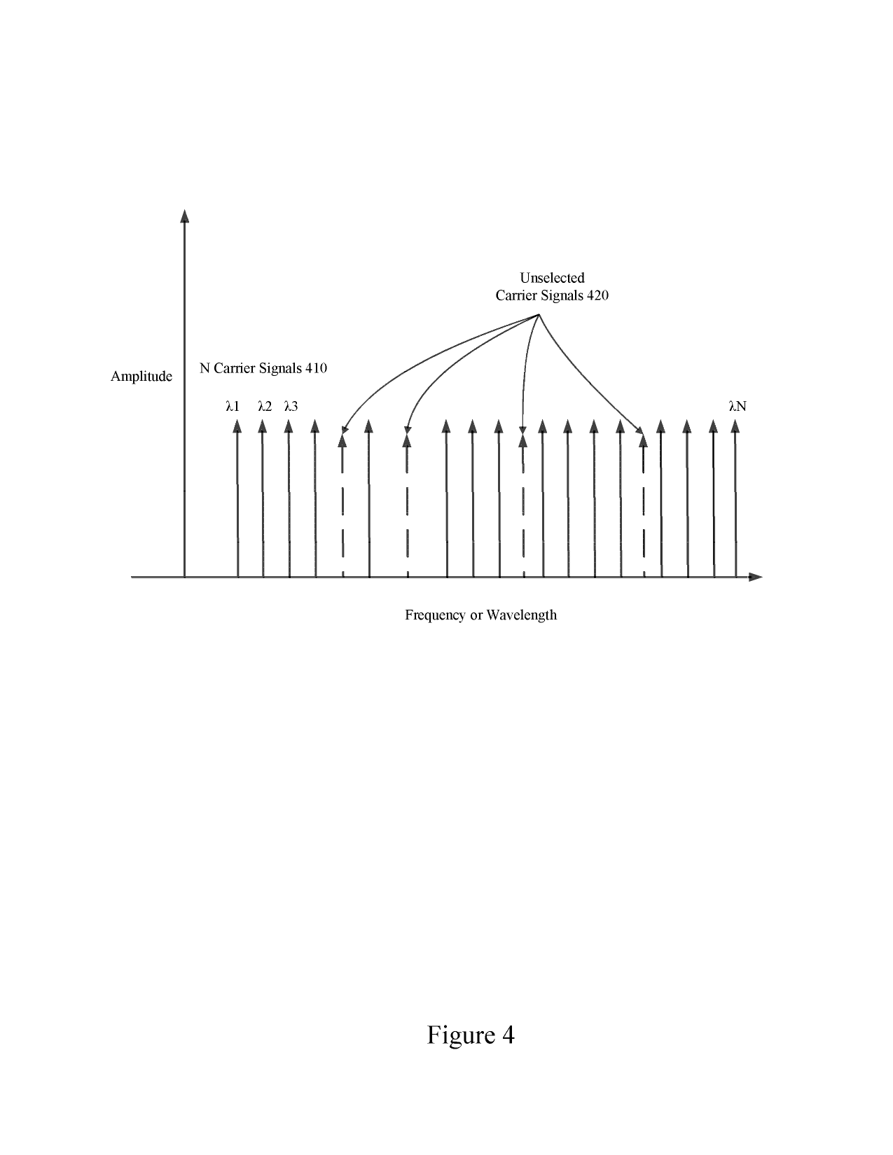

FIG. 4 is a frequency spectrum of carrier signals of the optical communication system, according to an embodiment. For an embodiment, the carrier signals are spaced 200 GHz apart from each other. As shown, the frequency spectrum may include the selected N or I carrier signals 410, and unselected carrier signals 420 of the M lasers. As previously described, the selection of the N or I lasers of the N or I carrier signals can be based on various communication quality parameters. For an embodiment, the N or I lasers are selected to provide the best level of communication quality. For an embodiment, the N or I lasers are selected to provide at least a threshold level of communication quality.

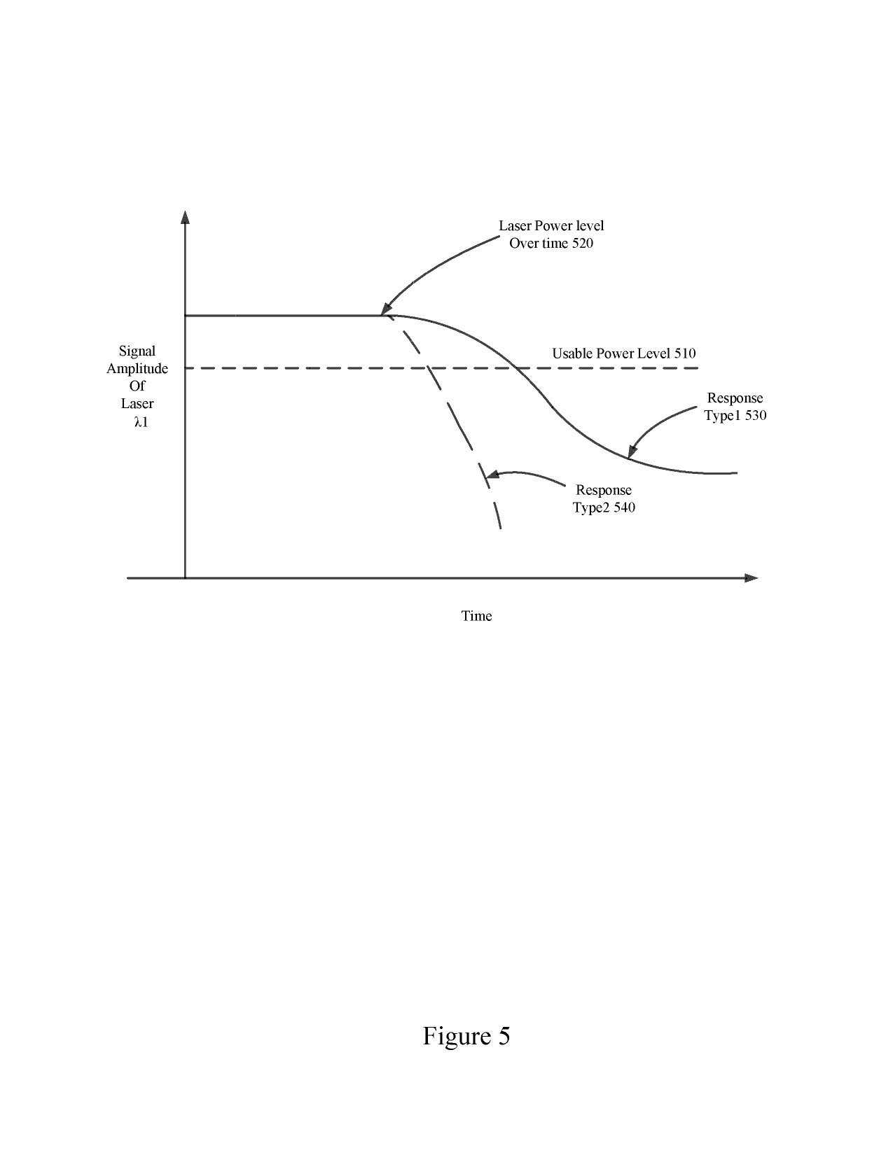

FIG. 5 shows power curves of a laser, according to an embodiment. As shown, the power level output of one or more of the M lasers may degrade over time. The units of time for the power curve (laser power level over time 520) of FIG. 5 may be small (fractional seconds) or very large (months or years). However, an expected life of the lasers can be estimated based on a rate of change of the power curve of the laser. Different power curves may exhibit different characteristics that can be used to identify specific or general potential problems with the laser. A first response type1 530 may degrade slowly. A second response type2 540 may degrade more quickly. The different degradation characteristics can be used to categorize and predict the life of the lasers. The sensed degradation of the lasers can be used to select how frequently to test the quality of each laser and reselect the N lasers. The sensed degradation of the lasers can be used to identify a laser to avoid selecting the degraded laser. As long as the output (signal amplitude) of the laser is above a usable power level 510, the laser may be selected for use.

In general, the failure modes of the lasers can be characterized into 3 different types: 1), infant mortality, which happens at the very early stages, and is usually screened by burn-in; 2), sudden failure, which results in a significant power drop in a very short time frame, but this can happen at a random time along the whole lifetime span of the laser; 3), gradual wear out, which shows a degradation trend over time, wherein some lasers can reach the performance threshold earlier, some laser later. If a signal carrier signal of a laser degrades below a selected quality threshold (useable power level 510), then a laser selection needs to be made to switch to using a different set of N lasers to ensure a desired level of performance of the optical transmitter system. Besides an output power drop, there are also other scenarios of laser degradation, such as, stress-relaxation induced wavelength change and bandwidth (modulation speed) change.

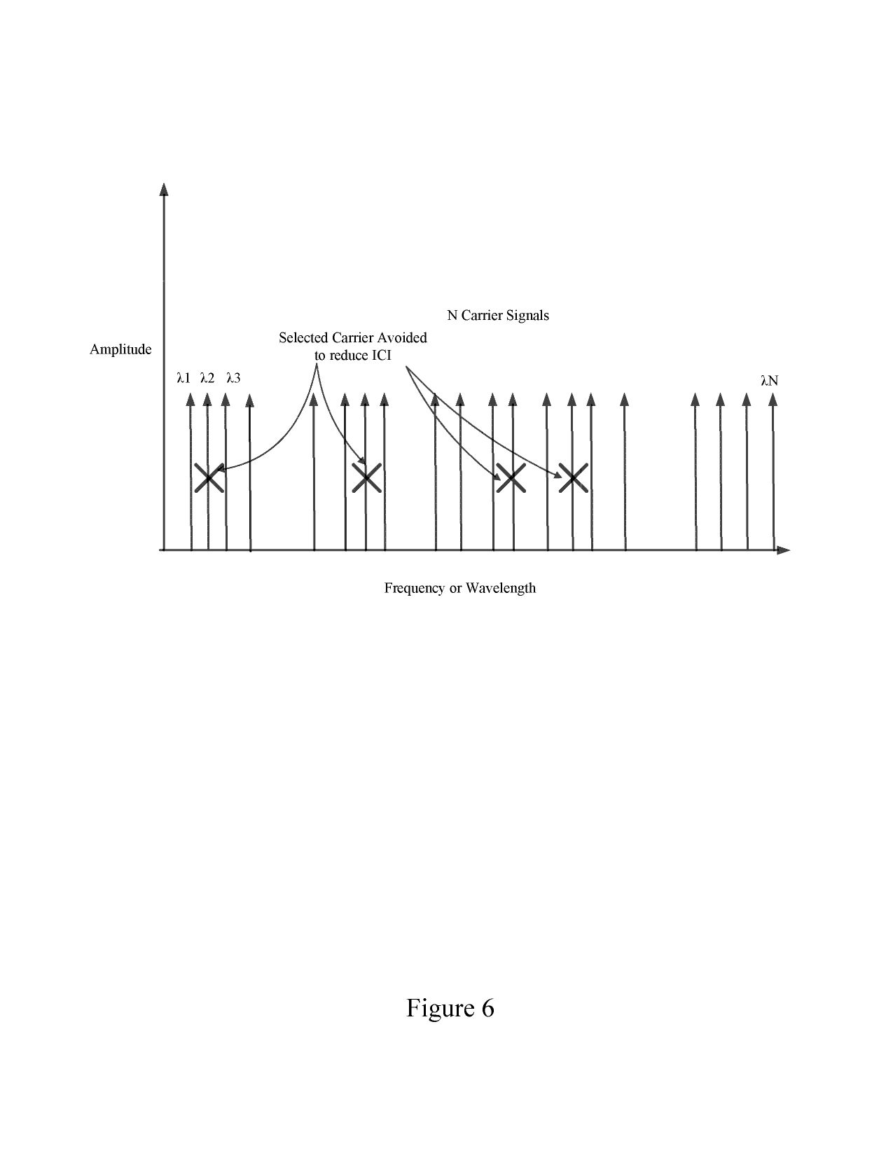

FIG. 6 shows a frequency spectrum of carrier signals of the optical communication system in which carrier signals are selected to reduce inter-channel interference, according to an embodiment. ICI can occur between different carrier signals of the N carrier signals. An embodiment includes mitigating ICI between carriers through the selection of the N carriers. That is, for example, if adjacent carrier signals suffer from a greater amount of ICI than desired, the carrier frequency locations can be adjusted through a reselection of the N or I lasers. For an embodiment, the N or I selected lasers are selected to maintain a selected frequency/wavelength spacing between each or one or more of the N or I carrier signals.

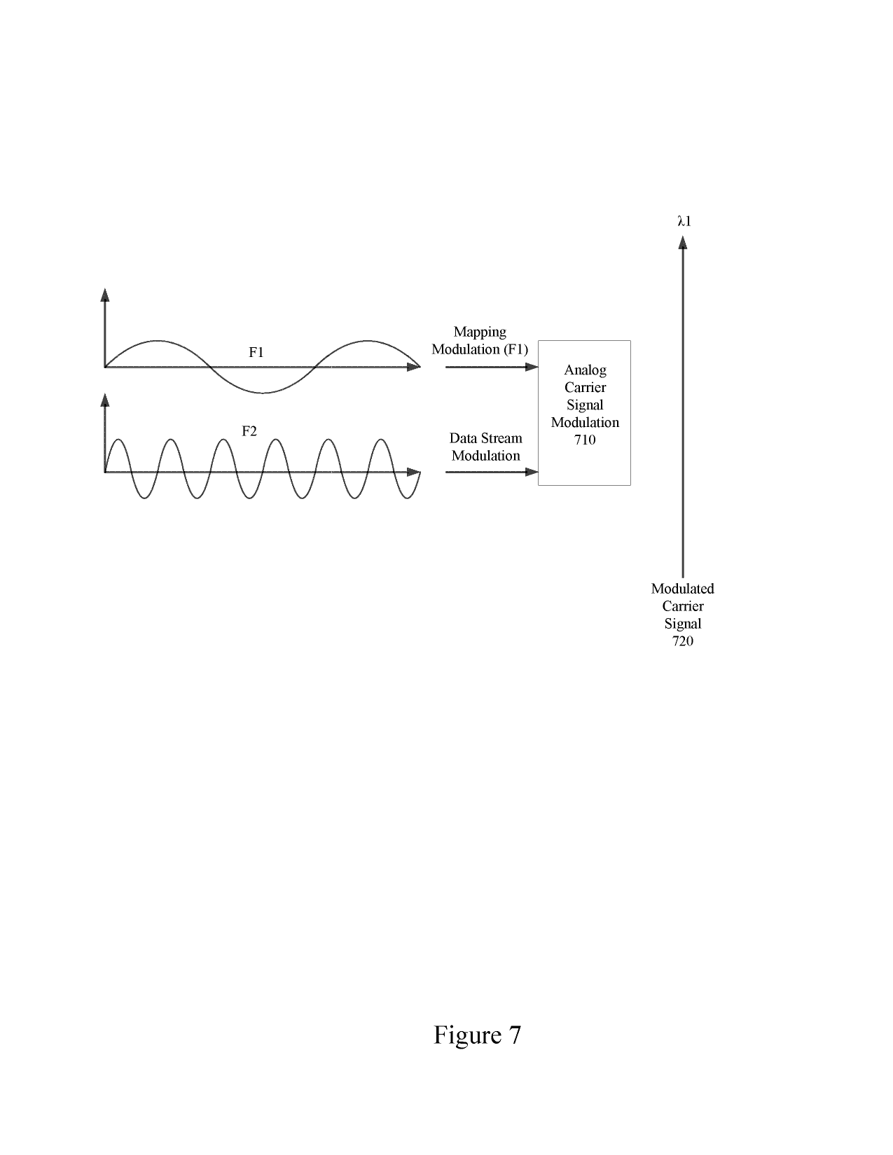

FIG. 7 shows a data stream and an analog signal modulated onto a carrier signal, according to an embodiment. As previously described, the mapping is communicated from the optical transmitter system 100 to the second optical receiver system 150. For an embodiment, the modulation of the carrier signals is implemented as analog modulation to reduce the need for DACs (digital to analog converters) and ADCs (analog to digital converters) which reduces power consumption of the optical transmitter system 100. It is to be understood that this modulation technique can be utilized for optical signals being transmitted over both directions of the optical fibers 160, 163.

FIG. 7 shows mapping modulating 710 a carrier signal 720 at a modulation rate of F1, and the data stream (laser data stream) modulating 710 the carrier signal 720 at a modulation rate of F2. Accordingly, the laser data stream and the mapping can be recovered at the first and second optical receiver systems 150, 153 by demodulating the carrier signal and determining the laser data stream by filtering for the F2 frequency and determining the mapping by filtering for the F1 frequency. As previously described, the mapping can include the mapping of the K bit streams to the N laser bit streams. Further, the mapping can include the mapping of the selected N of the M lasers.

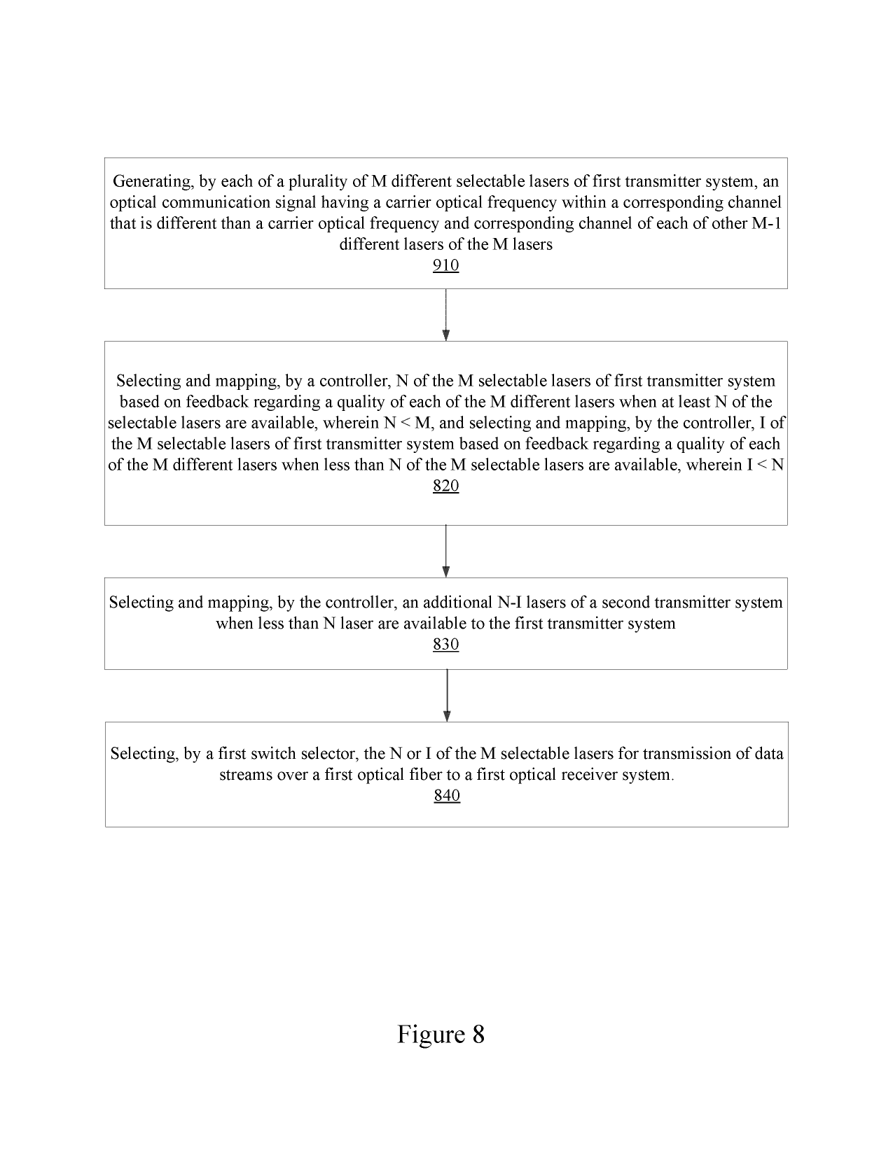

FIG. 8 is a flow chart that includes steps of a method of an optical communication system, according to an embodiment. A first step 810 includes generating, by each of a plurality of M different selectable lasers of first transmitter system, an optical communication signal having a carrier optical frequency within a corresponding channel that is different than a carrier optical frequency and corresponding channel of each of other M-1 different lasers of the M lasers. A second step 820 include selecting and mapping, by a controller, N of the M selectable lasers of first transmitter system based on feedback regarding a quality of each of the M different lasers when at least N of the selectable lasers are available, wherein N < M, and selecting and mapping, by the controller, I of the M selectable lasers of first transmitter system based on feedback regarding a quality of each of the M different lasers when less than N of the M selectable lasers are available, wherein I < N. A third step 830 includes selecting and mapping, by the controller, an additional N-I lasers of a second transmitter system when less than N laser are available to the first transmitter system. A fourth step 840 includes selecting, by a first switch selector, the N or I of the M selectable lasers for transmission of data streams over a first optical fiber to a first optical receiver system.

As previously described, at least some embodiments further include directing data stream of the N-I lasers of the first transmitter system to the second transmitter system when less than the N lasers are available at the first transmitter system, wherein the second transmitter system is configured to transmit the data streams of the N-I lasers over a second optical fiber to a second optical receiver system.

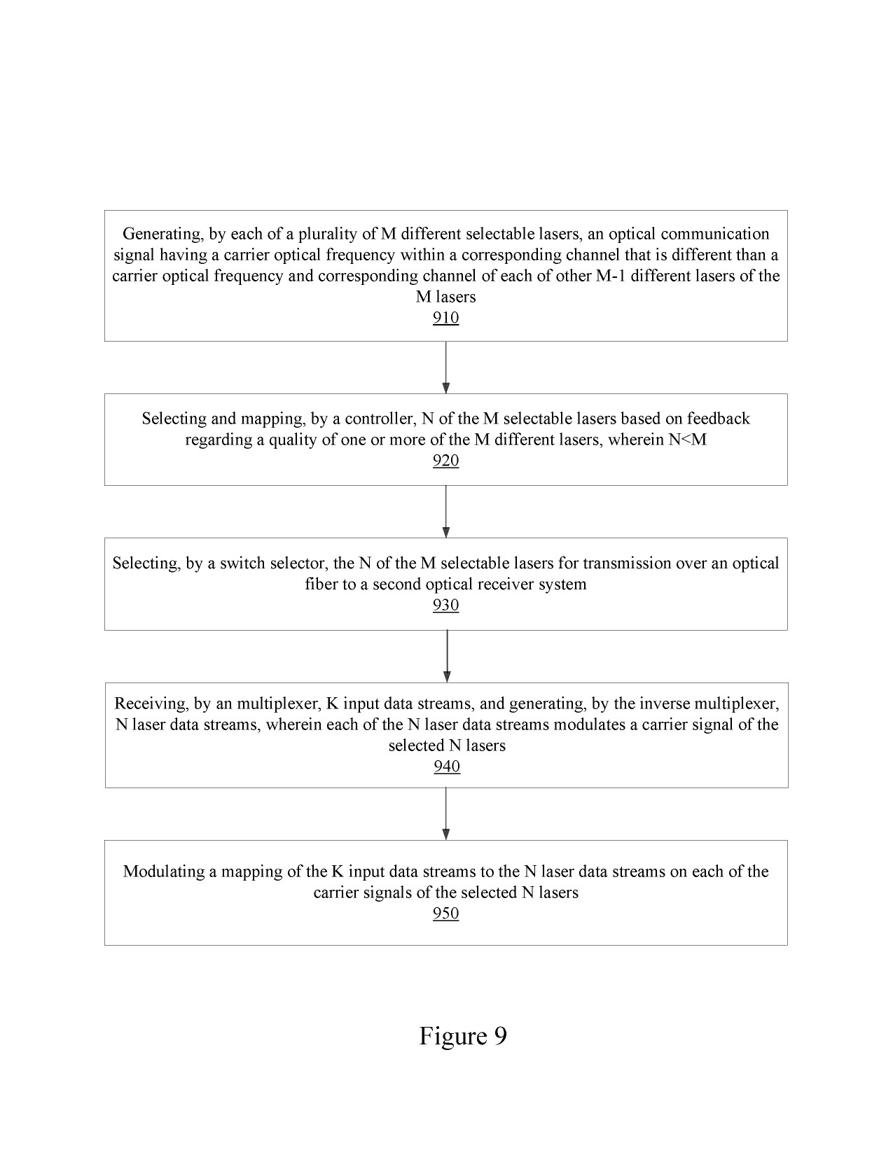

FIG. 9 is a flow chart that includes steps of a method of laser transmission, according to an embodiment. That is, an embodiment includes the utilization of the redundant optical lasers to maintain the N of the M lasers for selection within each of the optical transmitters when more than N lasers are available to the transmitter system. At least some of the previously described embodiments are utilized when fewer than N of the optical lasers are available. However, when N lasers are available, then the method of FIG. 9 is applicable. A first step 910 includes generating, by each of a plurality of M different selectable lasers, an optical communication signal having a carrier optical frequency within a corresponding channel that is different than a carrier optical frequency and corresponding channel of each of other M-1 different lasers of the M lasers. A second step 920 includes selecting and mapping, by a controller, N of the M selectable lasers based on feedback regarding a quality of one or more of the M different lasers, wherein N<M. A third step 930 includes selecting, by a switch selector, the N of the M selectable lasers for transmission over an optical fiber to a second optical receiver system. A fourth step 940 includes receiving, by a multiplexer, K input data streams, and generating, by the multiplexer, N laser data streams, wherein each of the N laser data streams modulates a carrier signal of the selected N lasers. A fifth step 950 includes modulating a mapping of the K input data streams to the N laser data streams on each of the carrier signals of the selected N lasers.

As described, each of the carrier optical frequencies corresponds with a different communication channel. For an embodiment, the passbands of each of the communication channels are not overlapping over the useful range of frequencies within each of the passbands.

At least some embodiments further include reselecting and mapping a new N of the M selectable lasers based on the quality received via the feedback. That is, over time the quality of the selected lasers may vary, and a reselection of the N of the M possible laser is made based on the feedback of the quality of the selected N lasers.

As previously described, for an embodiment, the optical transmitter system receives K input data streams. For an embodiment, the K input data streams are mapped to the selected N lasers after the N of the M selectable laser are mapped. As previously described, the K input data streams can be of varied data rates. For example, any one of the K input data streams may be 200 Gbps or 100 Gbps while each of the N laser data streams may be 50 Gbps. Any of the K input data streams may be 50Gbps or 25Gbps, while each of the N laser data streams may be 50Gbps. For an embodiment, the K input data streams are mapped to N laser data streams. The N selection is determined from the M lasers, and then the mapping of the K input data streams can be determined from the selected N lasers. For an embodiment, the second optical receiver system needs to know the mapping of the K input data streams to the N laser data streams so that the second optical receiver system can reconstruct the K input data streams after transmission through the optical fiber. Accordingly, for an embodiment the mapping of the K input data streams to the N selected lasers is communicated to the second optical receiver system.

For an embodiment, the switch selector selectively activates the N of the M lasers, wherein the unselected lasers are not activated. That is, unselected lasers are not activated which saves power and can extend the life of the unselected lasers. For an embodiment, quality characterizations of the lasers performed at one time are assumed to be retained for an unselected laser at a later time.

For an embodiment, mapping of the N of the M selectable lasers is modulated on M lasers. For an embodiment, mapping of the K input data stream to the N laser data streams is modulated on M lasers. Accordingly, the second optical receiver system can determine the mappings.

As previously described, for an embodiment, M is selected based on at least a projected end of life of the M different selectable lasers. As previously described, each laser can have a limited projected end of life. Accordingly, additional lasers can be included and selected from to ensure that at least a minimum number N of the lasers are available for use. For an embodiment, the number M is selected based on knowledge and estimates of the projected end of life of the M different selectable lasers. It is to be understood that the number of M different selectable lasers can additionally be selected based on a burn-in rate of the lasers, and/or a manufacturing yield of the lasers. For an embodiment, the redundancy of the transmission system allows for elimination of “Infant mortality testing” of the lasers, sudden failures of the lasers in field, and long-term gradual wear-out of the lasers in field.

As previously described, for an embodiment, the N selected lasers are selected based on a signal quality of each of the transmission signals of each of the M lasers. The signal quality can be determined in several different ways. For an embodiment, the N selected lasers are selected from the M lasers based on an estimated BER (bit error rate) of N modulated carrier signals. For an embodiment, the N selected lasers are selected to maintain a selected frequency spacing between each of the N carrier signals.

For an embodiment, MAC packets included as information within the modulated carrier signals of the N selected lasers include the mapping of the selection of the N of the M selectable lasers, thereby conveying the mapping to an optical receiver of the modulated carrier signals. Alternatively, or additionally, the information within the MAC packets includes the mapping of the K input data streams to the N laser data streams of the N selected lasers.

An embodiment further includes receiving feedback from a receiver of the N modulated lasers, and adaptively updates the mapping of the N of the M selectable lasers based on the received feedback. For an embodiment, the feedback includes measured values of the signal qualities of each of the N modulated carrier signals. Alternatively, or additionally, feedback is generated internally to the optical transmitter system and feedback to the controller.

An embodiment further includes tracking a history of the mapping over time, and adaptively influencing the selection of the N selected laser based on the history of the mapping. For example, tracking the performance over time can provide an indication of a particular one or more of the N selected laser in which the performance is degrading over time. Such degradation can be used to trigger a reselection of the N select lasers. Alternatively, the degradation may provide an indication that one or more lasers will fail, and therefore, trigger checking the selection of the N laser more frequently. For an embodiment, the indication that one or more of the lasers will fail triggers a reselection of the N laser that does not include the failing or previously failed laser.

An embodiment further includes coding selected and non-selected lasers with a same code and tracking a signal quality of both the selected and non-selected lasers. Non-selected lasers can be tracked by periodically or intermittently selecting the non-selected laser for characterization. However, an embodiment includes running an initial characterization of the M lasers. The initial characterization can be used to determine which lasers out of M are good-performing lasers, and the total number of good-performing (the best or better than a quality threshold) should be greater than N. For an embodiment, the N lasers are then selected, leaving several known good spare lasers (non-selected lasers). The other of the M non-selected lasers are power-off until they are to replace a failed laser. For an embodiment, it is assumed that the non-selected laser will not degrade during the time the lasers are power off, and therefore, the non-selected lasers do not need to be characterized at a later time. For an embodiment, when one or more of the N selected lasers needs to be replaced, then the entire M lasers can be recharacterized to ensure that the replacement laser is working as desired.

As previously described, an embodiment includes receiving feedback from a receiver of the N modulated lasers, and adaptively adjusts a coding of data streams of the modulated carriers. For an embodiment, the coding is across multiple carrier signals. For an embodiment, the coding is across carrier signals of the N selectable lasers. For an embodiment, the coding is across carrier signals of the M selectable lasers. As previously described, for an embodiment the feedback includes a received signal quality which is tracked over time, and wherein coding is increased for select of the N modulated carrier signals as the received signal quality of one or more of the N modulated carrier signals degrades over time.

As previously described, an embodiment includes receiving feedback from one or more sensors located within the optical transmitter system. As previously described, an embodiment includes receiving feedback from one or more sensors located within the second optical receiver system. Further, an embodiment includes receiving feedback from both the one or more sensors located within the optical transmitter system and from the one or more sensors located within the second optical receiver system. For an embodiment, the feedback includes signal quality (for example, power level) of the carrier signals of the optical lasers.

An embodiment includes adaptively adjusts an amplitude (power level) of the modulated carriers based on the feedback of the signal quality. For an embodiment, the feedback includes a received signal quality which is tracked over time, and wherein a bias current is increased for select of the N modulated carrier signals as the received signal quality of one or more of the N modulated carrier signals degrades over time.

As previously described, for an embodiment, a second optical transmitter system associated with the second optical receiver system is configured to generate a second set of carrier signals for transmission over the optical fiber to an optical receiver system associated with the optical transmitter system. For an embodiment, the carrier frequencies (wavelengths) of the second set a carrier signals are selected to result in a frequency guard band between the second set of carrier signals and the carrier frequencies (wavelengths) of the M different lasers, wherein the guard band is selected to reduce ICI between the optical transmitter system and the second optical transmitter system.

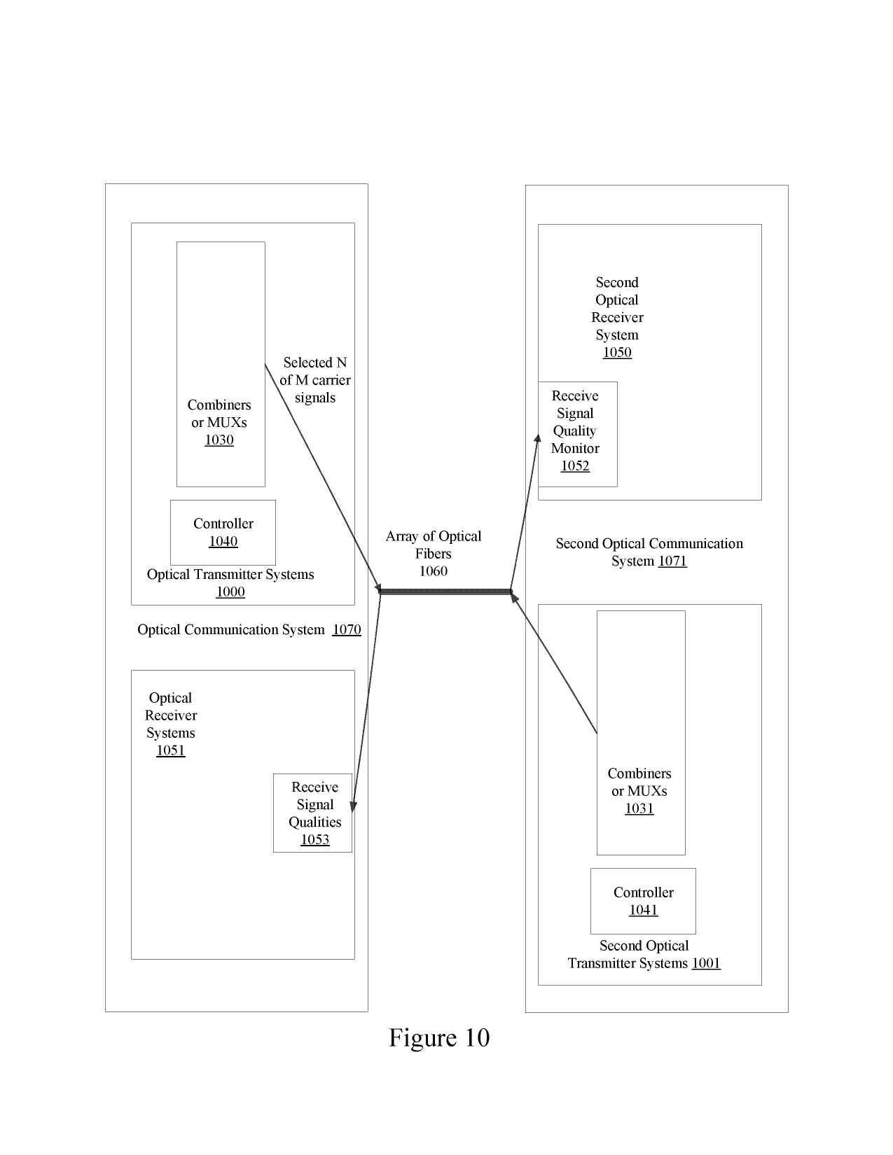

FIG. 10 shows a pair of optical communication systems, according to an embodiment. As shown, a first optical communication system 1070 includes an optical transmitter system 1000 and an optical receiver system 1051. A second optical communication system 1071 includes a second optical transmitter system 1001 and a second optical receiver system 1050. For an embodiment, both of the optical transmitter systems 1000, 1001 include the described embodiments for selecting N of M laser. As described, the optical transmitter system 1000 includes a controller 1040 and a set of combiners or MUXs 1030. Further, the second optical receiver system 1050 includes receive signal quality monitors 1052. Similarly, the second optical transmitter system 1001 includes a controller 1041 and a set combiners or MUXs 1031. Further, the optical receiver system 1051 includes receive signal quality monitor 1053. The optical signals of the optical lasers of the optical transmitter system 1000 and the second optical transmitter system 1001 propagate across an array of optical fiber 1060 to the second optical receiver system 1050 and the optical receiver system 1051.

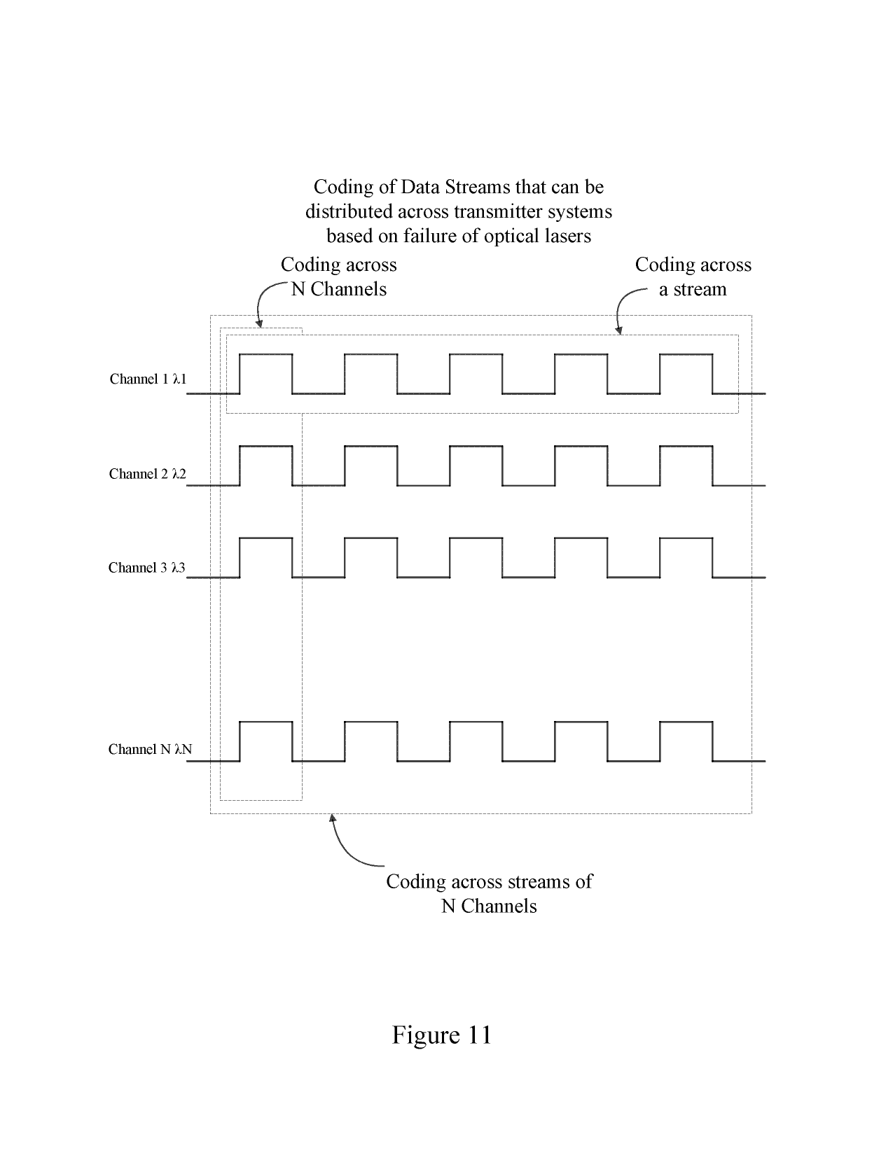

FIG. 11 shows examples of coding of laser transmission bit streams, according to embodiments. As previously described, bit streams of the laser system may be coded. For an embodiment, a bit stream of a laser may be coded to extend the life of a laser when the quality of the laser begins to degrade over time.

As shown in FIG. 11, for an embodiment, the coding is across a data stream. For another embodiment, the coding is across multiple channels. For an embodiment, the multiple channels include N channels corresponding to the N selected lasers. For an embodiment, the multiple channels include the M channels corresponding to the M lasers. For an embodiment, the multiple channels include AxM channels corresponding to M lasers of A optical transmitter systems. For an embodiment, the coding is across multiple channels and across a data stream of each of the multiple channels. Again, for an embodiment, the multiple channels include N channels corresponding to the N selected lasers. Again, for an embodiment, the multiple channels include the M channels corresponding to the M lasers. Again, for an embodiment, the multiple channels include AxM channels corresponding to M lasers of A optical transmitter systems.

Although specific embodiments have been described and illustrated, the embodiments are not to be limited to the specific forms or arrangements of parts so described and illustrated. The embodiments described are to only be limited by the claims.

What is claimed:

1. An optical communication system comprising:
a first transmitter system, comprising:
M different selectable lasers, each of the M different lasers configured to generate an optical communication signal having a carrier optical frequency within a corresponding channel that is different than a carrier optical frequency and corresponding channel of each of other M-1 different lasers of the M lasers;
a controller configured to:
select and map N of the M selectable lasers based on feedback regarding a quality of each of the M different lasers when at least N of the selectable lasers are available, wherein N < M, and configured to select and map I of the M selectable lasers based on feedback regarding a quality of each of the M different lasers when less than N of the M selectable lasers are available, wherein I < N;
wherein a second transmitter system is configured to select and map an additional N-I lasers to accommodate for the less than N laser available to the first transmitter when less than N lasers are available; and
a first switch selector configured to select the N or I of the M selectable lasers for transmission over a first optical fiber to a first optical receiver system.

2. The optical communication system of claim 1, wherein the controller is further configured to communicate mapping of the N of the M selectable lasers to the first optical receiver system when at least N of the selectable lasers are available and communicate mapping I of the M selectable lasers to the first optical receiver system when less than N of the M selectable lasers are available.

3. The optical communication system of claim 1, wherein data stream of the N-I lasers of the first transmitter system are directed to the second transmitter system when less than the N lasers are available at the first transmitter system, wherein the second transmitter system is configured to transmit the data streams of the N-I lasers over a second optical fiber to a second optical receiver system.

4. The optical communication system of claim 1, further comprising:
the second transmitter system comprising:
X different selectable lasers, each of the X different lasers configured to generate an optical communication signal having a carrier optical frequency within a corresponding channel that is different than a carrier optical frequency and corresponding channel of each of other X-1 different lasers of the X lasers;
the controller configured to:
select and map an additional N-I lasers at the second transmitter system to accommodate for the less than N laser available to the first transmitter system:
select and map Y + (N-I) of the X selectable lasers based on feedback regarding a quality of each of the X different lasers, wherein Y + (N-I) <= X; and
a second switch selector configured to select the Y + (N-I) of the X selectable lasers for transmission over a second optical fiber to a second optical receiver system.

5. The optical communication system of claim 4, wherein M = X, and N = Y.

6. The optical communication system of claim 4, wherein the controller is further configured to select and map an additional Y - Z lasers to another transmitter system when less than Y lasers are available to the second transmitter system, wherein Z < Y.

7. The optical communication system of claim 4, wherein the controller is further configured to:
select and map N + (Y-Z) of the M selectable lasers based on feedback regarding a quality of each of the M different lasers, wherein N + (Y-Z) <= M; and
the first switch selector configured to select the N + (Y-Z) of the M selectable lasers for transmission over the first optical fiber to the first optical receiver system.

8. The optical communication system of claim 4, wherein the controller is further configured to
select and map Y of the X selectable lasers based on feedback regarding a quality of each of the X different lasers when at least X of the selectable lasers are available, wherein Y < X, and configured to select and map Z of the X selectable lasers based on feedback regarding a quality of each of the X different lasers when less than X of the Y selectable lasers are available, wherein Z < Y;
select and map an additional Y-Z lasers to accommodate for the less than Y laser available to the second transmitter when less than Y lasers are available;
and further comprising a second switch selector of the second transmitter system configured to select the Y or Z of the M selectable lasers for transmission over a second optical fiber to a second optical receiver system.

9. The optical communication system of claim 5, further comprising A transmitter systems including the first transmitter system and the second transmitter system, wherein when one or more of the A transmitter systems do not have N lasers available, then one of more lasers of other of the A transmitter systems are selected to transmit data streams originally allocated to the N lasers not available.

10. The optical communication system of claim 9, wherein the lasers of the other of the A transmitter systems are selected based on a signal quality of optical signals generated by the lasers.

11. The optical communication system of claim 9, wherein the lasers of the other of the A transmitter systems are selected based on a thermal distribution of the lasers.

12. The optical communication system of claim 9, wherein the lasers of the other of the A transmitter systems are selected based on crosstalk of the lasers.

13. The optical communication system of claim 9, wherein A x N of A x M selected lasers are activated and the unselected lasers are not activated.

14. The optical communication system of claim 9, wherein the mapping of the A x N of A x M selected lasers is modulated on A x M lasers.

15. The optical communication system of claim 9, further comprising:
a multiplexer configured to receive K input data streams and generate A x N laser data streams, wherein each of the A x N laser data streams modulates a carrier signal of the selected A x N lasers;
wherein a mapping of the A x K input data streams to the N laser data streams is modulated on each of the carrier signals of the selected N lasers.

16. The system of claim 1, wherein A x M is selected based on at least a projected end of life of the M different selectable lasers.

17. The system of claim 1, wherein the controller is further configured to receive feedback from a receiver of the N modulated lasers, and adaptively update the mapping of the N of the M selectable lasers based on the received feedback.

18. The system of claim 1, wherein the controller is further configured to track a history of the mapping over time, and adaptively influence the selection of the N or I selected laser based on the history of the mapping.

19. A method, comprising:
generating, by each of a plurality of M different selectable lasers of first transmitter system, an optical communication signal having a carrier optical frequency within a corresponding channel that is different than a carrier optical frequency and corresponding channel of each of other M-1 different lasers of the M lasers;
selecting and mapping, by a controller, N of the M selectable lasers of first transmitter system based on feedback regarding a quality of each of the M different lasers when at least N of the selectable lasers are available, wherein N < M, and selecting and mapping, by the controller, I of the M selectable lasers of first transmitter system based on feedback regarding a quality of each of the M different lasers when less than N of the M selectable lasers are available, wherein I < N;
selecting and mapping, by the controller, an additional N-I lasers of a second transmitter system when less than N laser are available to the first transmitter system; and
selecting, by a first switch selector, the N or I of the M selectable lasers for transmission of data streams over a first optical fiber to a first optical receiver system.

20. The method of claim 19, further comprising directing data stream of the N-I lasers of the first transmitter system to the second transmitter system when less than the N lasers are available at the first transmitter system, wherein the second transmitter system is configured to transmit the data streams of the N-I lasers over a second optical fiber to a second optical receiver system.
